(19) United States
(12) Patent Application Publication
(10) Pub. No.: US 2024/0026178 A1
(43) Pub. Date: Jan. 25, 2024

(54) INKJET INK

(71) Applicant: KYOCERA Document Solutions Inc., Osaka (JP)

(72) Inventor: Kazuki TSUCHIHASHI, Osaka-shi (JP)

(73) Assignee: KYOCERA Document Solutions Inc., Osaka (JP)

(21) Appl. No.: 18/355,272

(22) Filed: Jul. 19, 2023

(30) Foreign Application Priority Data
Jul. 25, 2022 (JP) 2022-118011

(51) Int. Cl. C09D 11/326; C09D 11/033; C09D 11/037; C09D 11/106

(52) U.S. Cl. CPC C09D 11/326; C09D 11/033; C09D 11/037; C09D 11/106

(57) ABSTRACT

An inkjet ink contains an aqueous medium and pigment particles dispersed in the aqueous medium. The pigment particles contain a pigment and a specific resin. The specific resin includes an acid group and a first repeating unit derived from a specific monomer, and has a crosslinking structure derived from a carbodiimide crosslinking agent. The specific resin has a neutralization rate of at least 20% and no greater than 50%. The first repeating unit has a percentage content in the specific resin of at least 1.0% by mass and no greater than 20.0% by mass. The specific monomer has a morpholine structure or a pyrrolidone structure.

The present application claims priority under 35 U.S.C. § 119 to Japanese Patent Application No. 2022-118011, filed on Jul. 25, 2022. The contents of this application are incorporated herein by reference in their entirety.

### BACKGROUND

The present disclosure relates to an inkjet ink.

Some inkjet recording apparatus uses a water-based inkjet ink containing a pigment and an aqueous medium. The inkjet ink is demanded to have excellent preservation stability and be able to inhibit occurrence of nozzle clogging in a recording head of an inkjet recording apparatus.

In order to meet such demands, an inkjet ink is proposed that uses a colorant dispersion containing colorant particles, a basic compound, a crosslinking agent, and water, for example. The above inkjet ink is said to have excellent preservation stability.

### SUMMARY

An inkjet ink according to an aspect of the present disclosure contains an aqueous medium and pigment particles dispersed in the aqueous medium. The pigment particles contain a pigment and a specific resin. The specific resin includes an acid group and a first repeating unit derived from a specific monomer, and has a crosslinking structure derived from a carbodiimide crosslinking agent. The specific resin has a neutralization rate of at least 20% and no greater than 50%. The first repeating unit has a percentage content in the specific resin of at least 1.0% by mass and no greater than 20.0% by mass. The specific monomer has a morpholine structure or a pyrrolidone structure.

### DETAILED DESCRIPTION

The following describes an embodiment of the present disclosure. In the following, measurement values for volume median diameter (D50) are values as measured using a dynamic light scattering type particle size distribution analyzer (“ZETASIZER (registered Japanese trademark) NANO ZS”, product of Malvern Instruments Ltd.) unless otherwise stated.

In the present specification, acid values can be measured according to the method described in the Japanese Industrial Standards (JIS) K0070:1992.

In the present specification, the term “(meth)acryl” is used as a generic term for both acryl and methacryl. In the present specification, an “acid group” includes not only unneutralized acid groups but also neutralized acid groups (e.g., —COONa and COOK).

<Inkjet Ink>

The following describes an inkjet ink (also referred to below simply as ink) according to an embodiment of the present disclosure. The inkjet ink of the present disclosure contains an aqueous medium and pigment particles dispersed in the aqueous medium. The pigment particles contain a pigment and a specific resin. The specific resin includes an acid group and a first repeating unit derived from a specific monomer, and has a crosslinking structure derived from a carbodiimide crosslinking agent. The specific resin has a neutralization rate of at least 20% and no greater than 50%. The first repeating unit has a percentage content in the specific resin of at least 1.0% by mass and no greater than 20.0% by mass. The specific monomer has a morpholine structure or a pyrrolidone structure.

In the present specification, the term neutralization rate refers to the percentage of a neutralized acid group where the total percentage of the acid group including the neutralized acid group and the unneutralized acid group included in the specific resin is 100%. The neutralization rate can be calculated for example from the amount of a basic compound used for neutralization of the specific resin in preparation of the specific resin. Specifically, the neutralization rate is a percentage (100×MB/MA) of an amount MB of use to a theoretical value MA where the theoretical value MA represents a theoretical value of the amount of the basic compound necessary for completely neutralizing the specific resin and the amount MB of use represents the amount of the basic compound used in neutralization of the specific resin. Note that MA is calculated from the monomer composition of the specific resin, for example.

No specific limitations are placed on use of the ink of the present disclosure, and the ink of the present disclosure may be used for image formation on a permeable recording medium and a non-permeable recording medium, for example. The ink of the present disclosure is suitable for image formation on the permeable recording medium. The permeable recording medium can allow a large amount of ink to penetrate. Examples of the permeable recording medium include printing paper and a medium (e.g., fabric) of which raw material is fiber. Examples of the printing paper include plain paper, copier paper, recycled paper, thin paper, thick paper, and glossy paper.

As a result of having the above features, the ink of the present disclosure can have excellent preservation stability and inhibit occurrence of nozzle clogging. The reasons thereof can be inferred as follows. The pigment particles contained in the ink of the present disclosure contain a pigment and a specific resin. The specific resin has a crosslinking structure derived from a carbodiimide crosslinking agent. As a result of the specific resin being crosslinked in the pigment particles, the specific resin can be inhibited from being desorbed from the pigment particles. As such, agglomeration of the pigment particles caused by decrease in dispersibility thereof resulting from desorption of the specific resin from the pigment particles can be inhibited in the ink of the present disclosure.

In a case in which the specific resin has extremely high hydrophilicity, affinity of the specific resin and the pigment particles may decrease to cause desorption of the specific resin from the surfaces of the pigment particles to an aqueous medium. In a case in which the specific resin has extremely low hydrophilicity by contrast, dispersion stability of the pigment particles decreases. Therefore, the specific resin is required to have moderately high hydrophilicity. However, the crosslinking structure derived from a carbodiimide crosslinking agent, which the specific resin has, tends to have low hydrophilicity compared with crosslinking agents derived from other crosslinking agents (e.g., an epoxy crosslinking agent and an oxazoline crosslinking agent). In view of the foregoing, a structure with high hydrophilicity is introduced to the specific resin in order that the specific resin exhibits moderately high hydrophilicity. Specifically, an acid group, which has a highly hydrophilic structure, is introduced to the specific resin. Furthermore, a certain proportion or more of the acid group in the specific resin is neutralized. Therefore, further high hydrophilicity is imparted to the specific resin. In addition, an appropriate amount of the first repeating unit derived from a specific monomer is introduced to the specific resin. Here, the specific monomer has a morpholine structure or a pyrrolidone structure, both of which have high hydrophilicity. Therefore, the specific resin can exhibit moderately high hydrophilicity. As a result, the pigment particles can exhibit high dispersion stability. Furthermore, the pigment particles of the ink of the present disclosure have high hydrophilicity. Therefore, even when the pigment particles precipitate on the surface of a nozzle of the recording head of an inkjet recording apparatus, the precipitated pigment particles can be easily re-dissolved. For the above reasons, the ink of the present disclosure can have excellent preservation stability and inhibit occurrence of nozzle clogging.

The ink of the present disclosure is described below further in detail. For each component indicated in the following description, one type of the component may be used independently, or two or more types of the component may be used in combination.

### [Pigment Particles]

The pigment particles contain a pigment and a specific resin. The pigment particles are each constituted by a core containing a pigment and a specific resin covering the core. The total percentage content of the pigment and the specific resin in the pigment particles is preferably at least 90% by mass, and more preferably 100% by mass.

In terms of optimizing color density, hue, or stability of the ink of the present disclosure, the pigment particles have a volume median diameter of preferably at least 30 nm and no greater than 200 nm, and more preferably at least 80 nm and no greater than 130 nm.

The pigment particles have a percentage content in the ink of the present disclosure of preferably at least 3.0% by mass and no greater than 20.0% by mass, and more preferably at least 7.0% by mass and no greater than 14.0% by mass. As a result of the percentage content of the pigment particles being set to at least 3.0% by mass, the ink of the present disclosure can form images with desired image density. As a result of the percentage content of the pigment particles being set to no greater than 20.0% by mass by contrast, fluidity of the ink of the present disclosure can be optimized.

(Pigment)

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, specifically 15:3). Examples of the violet pigments include C.I. Pigment Violet (19, 23, or 33). Examples of the black pigments include C.I. Pigment Black (7).

The pigment has a content ratio in the ink of the present disclosure of preferably at least 2.0 parts by mass and no greater than 15.0 parts by mass, and more preferably at least 5.0 parts by mass and no greater than 10.0 parts by mass. The pigment has a percentage content in the pigment particles of preferably at least 50% by mass and no greater than 90% by mass, and more preferably at least 70% by mass and no greater than 80% by mass.

(Specific Resin)

The specific resin covers the pigment in the pigment particles, for example. The specific resin includes an acid group and a first repeating unit derived from a specific monomer, and has a crosslinking structure derived from a carbodiimide crosslinking agent.

The specific monomer has a morpholine structure or a pyrrolidone structure. Examples of the specific monomer include vinyl compounds with a morpholine structure or a pyrrolidone structure. Specific examples of the specific monomer include vinyl pyrrolidone, vinyl morpholine, 2-acryloyl morpholine, and 2-methacryloyl morpholine. The specific monomer is preferably vinyl pyrrolidone or 2-acryloyl morpholine.

The first repeating unit has a percentage content in the specific resin of at least 1.0% by mass and no greater than 20.0% by mass, and preferably at least 3.0% by mass and no greater than 8.0% by mass. As a result of the percentage content of the first repeating unit being set to at least 1.0% by mass, moderately high hydrophilicity can be imparted to the specific resin. Accordingly, the ink of the present disclosure can exhibit excellent preservation stability and inhibit occurrence of nozzle clogging. As a result of the percentage content of the first repeating unit being set to no greater than 20.0% by mass, the specific resin can be inhibited from being too hydrophilic. Accordingly, desorption of the specific resin from the pigment particles can be inhibited, so that the ink of the present disclosure can exhibit excellent preservation stability.

The specific resin has a neutralization rate of at least 20% and no greater than 50%, and preferably at least 30% and o greater than 45%. As a result of the neutralization rate of the specific resin being set to at least 20%, moderately high hydrophilicity can be imparted to the pigment particles. Accordingly, the ink of the present disclosure can inhibit occurrence of nozzle clogging. The crosslinking structure of the specific resin is formed mainly in an unneutralized acid group. Therefore, as a result of the neutralization rate of the specific resin being set to no greater than 50%, the crosslinking structure can be introduced into the specific resin to a moderate extent. Accordingly, the ink of the present disclosure can exhibit excellent preservation stability.

In the ink of the present disclosure, the specific resin has a content ratio of preferably at least 0.3 parts by mass and no greater than 10.0 parts by mass, and more preferably at least 1.5 parts by mass and no greater than 3.0 parts by mass. The pigment particles has a percentage content in the pigment particles of preferably at least 10% by mass and no greater than 50% by mass, and more preferably at least 20% by mass and no greater than 30% by mass.

Examples of the carbodiimide crosslinking agent include aromatic polycarbodiimides, alicyclic polycarbodiimides, and aliphatic polycarbodiimides. Examples of the aromatic polycarbodiimides include poly(4,4′-diphenylmethane carbodiimide), poly(p-phenylene carbodiimide), poly(m-phenylene carbodiimide), poly(diisopropylphenyl carbodiimide), and poly(triisopropylphenyl carbodiimide). An example of the alicyclic polycarbodiimides include poly(dicyclohexylmethane carbodiimide). An example of the aliphatic polycarbodiimides is poly(diisopropyl carbodiimide). Examples of commercially available carbodiimide crosslinking agents include “CARBODILITE (registered Japanese trademark) SV-02”, “CARBODILITE V-02”, “CARBODILITE V-02-L2”, “CARBODILITE V-04”, “CARBODILITE E-01”, and “CARBODILITE E-02” each produced by Nisshinbo Chemical Inc.

Preferably, the specific resin further includes a second repeating unit derived from a monomer with a polyethylene glycol structure. The monomer with a polyethylene glycol structure is preferably methoxy-polyethylene glycol (meth)acrylate. The methoxy-polyethylene glycol (meth)acrylate has a repeating structure represented by (—CH₂—CH₂—O—)n (where n represents an integer of at least 2) in its molecule. n is preferably at least 5 and no greater than 20, and more preferably at least 7 and no greater than 12.

The second repeating unit has a percentage content in the specific resin of preferably at least 5.0% by mass and no greater than 50.0% by mass, and more preferably at least 20.0% by mass and no greater than 35.0% by mass. As a result of the percentage content of the second repeating unit being set to at least 5.0% by mass, moderately high hydrophilicity can be imparted to the specific resin. As a result of the percentage content of the second repeating unit being set to no greater than 50.0% by mass, occurrence of bridging agglomeration of the pigment particles can be inhibited.

Preferably, the specific resin further includes a third repeating unit derived from a carboxy group-containing monomer. Examples of the carboxy group-containing monomer include (meth)acrylic acid, polybasic carboxylic acid, polybasic carboxylic acid derivatives, and unsaturated carboxylic acid. The acid group that the specific resin includes may be included in only the third repeating unit or may be included in another portion (e.g., another repeating unit or an end group).

The third repeating unit has a percentage content in the specific resin of preferably at least 15.0% by mass and no greater than 50.0% by mass, and more preferably at least by mass and no greater than 35.0% by mass. As a result of the percentage content of the third repeating unit being set to at least 15.0% by mass, moderately high hydrophilicity can be imparted to the specific resin and a crosslinking structure can be introduced into the specific resin to a moderate extent. As a result of the percentage content of the third repeating unit being set to no greater than 50.0% by mass, the specific resin can be inhibited from being excessively hydrophilic.

The specific resin may be a random polymer or a block polymer. The specific resin is preferably a random polymer. Specific examples of the specific resin include reaction products of a carbodiimide crosslinking agent and at least one resin of polyester resin, urethane resin, (meth)acrylic resin, styrene-maleic acid copolymers, styrene-maleic acid half-ester copolymers, vinylnaphthalene-(meth)acrylic acid copolymers, and vinylnaphthalene-maleic acid copolymers.

((Meth)Acrylic Resin)

The specific resin is preferably a reaction product of a carbodiimide crosslinking agent and (meth)acrylic resin. The (meth)acrylic resin includes for example the first repeating unit and a repeating unit derived from (meth)acrylic acid as the third repeating unit. Preferably, the (meth)acrylic resin further includes the aforementioned second repeating unit.

Preferably, the (meth)acrylic resin further includes a repeating unit derived from (meth)acrylic acid alkyl ester. Examples of the (meth)acrylic acid alkyl ester include methyl (meth)acrylate, ethyl (meth)acrylate, propyl (meth)acrylate, and n-butyl (meth)acrylate.

The repeating unit derived from (meth)acrylic acid alkyl ester has a percentage content in the (meth)acrylic resin of preferably at least 2.0% by mass and no greater than by mass, and more preferably at least 5.0% by mass and no greater than 15.0% by mass.

Preferably, the (meth)acrylic resin further includes a repeating unit (also referred to below as styrene unit) derived from styrene or a styrene derivative. An example of the styrene derivative is a-methylstyrene. The styrene unit has a percentage content in the (meth)acrylic resin of preferably at least 5.0% by mass and no greater than 50.0% by mass, and more preferably at least 20.0% by mass and no greater than 40.0% by mass. Note that the (meth)acrylic resin further including a styrene unit may be also referred to below as styrene-(meth)acrylic resin.

Preferably, the (meth)acrylic resin further includes a repeating unit derived from (meth)acrylic acid aryl ester. Examples of the (meth)acrylic acid aryl ester include phenyl (meth)acrylate and benzyl (meth)acrylate. The repeating unit derived from (meth)acrylic acid aryl ester has a percentage content in the (meth)acrylic resin of preferably at least 10.0% by mass and no greater than 50.0% by mass, and more preferably at least 20.0% by mass and no greater than 40.0% by mass.

Preferably, the raw monomers of the (meth)acrylic resin are any of the following combinations (I) to (V).
Combination (I): benzyl methacrylate, n-butyl acrylate, methacrylic acid, methoxy-polyethylene glycol acrylate, and 2-acryloyl morpholine
Combination (II): benzyl methacrylate, n-butyl acrylate, methacrylic acid, methoxy-polyethylene glycol acrylate, and vinyl pyrrolidone
Combination (III): styrene, ethyl methacrylate, methacrylic acid, methoxy-polyethylene glycol acrylate, and 2-acryloyl morpholine.
Combination (IV): styrene, α-methylstyrene, n-butyl acrylate, methacrylic acid, methoxy-polyethylene glycol acrylate, and 2-acryloyl morpholine
Combination (V): styrene, n-butyl acrylate, methacrylic acid, methoxy-polyethylene glycol acrylate, and 2-acryloyl morpholine

### [Aqueous Medium]

The aqueous medium contained in the ink of the present disclosure is a medium containing water. The aqueous medium may function as a solvent or function as a dispersion medium. Specific examples of the aqueous medium include water and an aqueous medium containing a water-soluble organic solvent.

(Water)

The water has a percentage content in the ink of the present disclosure of preferably at least 50.0% by mass and no greater than 90.0% by mass, and more preferably at least 60.0% by mass and no greater than 85.0% by mass.

(Water-Soluble Organic Solvent)

Examples of the water-soluble organic solvent include glycol compounds, triol compounds, glycol ether compounds, lactam compounds, nitrogen-containing compounds, acetate compounds, thiodiglycol, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. A preferable glycol compound is 1,2-pentanediol, 3-methyl-1,3-butanediol, or 3-methyl-1,5-pentanediol.

Examples of the triol compounds include glycerin and 1,2,3-butanetriol. A preferable triol compound is glycerin.

Examples of the glycol ether compounds include diethylene glycol, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether. A preferable glycol ether compound is triethylene glycol monobutyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent is preferably a glycol compound, a triol compound, or a glycol ether compound, and more preferably a solvent mixture obtained by mixing the following combination (i) or (ii).
Combination (i): glycerin, 3-methyl-1,5-pentanediol, and triethylene glycol monobutyl ether
Combination (ii): glycerin, 3-methyl-1,3-butanediol, and 1,2-pentanediol

The water-soluble organic solvent has a percentage content in the ink of the present disclosure of preferably at least 3.0% by mass and no greater than 30.0% by mass, and more preferably at least 8.0% by mass and no greater than 15.0% by mass.

### [Surfactant]

Preferably, the ink of the present disclosure further contains a surfactant. The surfactant can optimize penetrability (wettability) of the ink of the present disclosure to a recording medium. Examples of the surfactant include an anionic surfactant, a cationic surfactant, and a nonionic surfactant. The surfactant is preferably a nonionic surfactant.

Examples of the nonionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and ethylene oxide adducts of acetylene glycol. The nonionic surfactant is preferably an ethylene oxide adduct of acetylene glycol.

The surfactant has a percentage content in the ink of the present disclosure of preferably at least 0.05% by mass and no greater than 3.0% by mass, and more preferably at least 0.1% by mass and no greater than 1.0% by mass.

### [Other Components]

The ink of the present disclosure may further contain any known additive (e.g., any of a solution stabilizer, an anti-drying agent, an antioxidant, a viscosity modifier, a pH adjuster, and an antifungal agent) as necessary.

### [Ink Production Method]

Next, an example of a method for producing the ink of the present disclosure is described. The method for producing the ink of the present disclosure includes for example a dispersion process, a crosslinking process, and an addition process. In the dispersion process, a pre-crosslinked specific resin (also referred to below as base resin) and the pigment are dispersed in water to prepare a pigment particle dispersion. In the crosslinking process, the carbodiimide crosslinking agent is added to the pigment particle dispersion. In the addition process, the aqueous medium is added to the pigment particle dispersion after the crosslinking process to prepare the ink.

(Dispersion Process)

In the present process, a pigment particle dispersion is prepared by dispersing the pigment and the based resin in water. Examples of a disperser used in the dispersion process include wet dispersion apparatuses such as a media type disperser.

The base resin used in the present process is preferably prepared in advance to have a desired neutralization rate (at least 20% and no greater than 50%) by neutralization with a base compound (e.g., KOH or NaON). However, the base resin may be neutralized in a process following the present process.

In the present process, the percentage content of the base resin in a solution used for dispersion is at least 5.0% by mass and no greater than 25.0% by mass, for example. The percentage content of the pigment in the solution used for dispersion is at least 1.0% by mass and no greater than 10.0% by mass, for example. In the present process, preferably, the solution used for dispersion further contains a defoaming agent. The percentage content of the defoaming agent in the solution used for dispersion is at least by mass and no greater than 0.1% by mass, for example.

In the present process, it is preferable to remove coarse particles contained in the resultant pigment particle dispersion by filtration using a filter (with a pore diameter of 5 μm, for example).

(Crosslinking Process)

In the present process, the carbodiimide crosslinking agent is added to the pigment particle dispersion. By doing so, the base resin contained in the pigment particle dispersion reacts with the carbodiimide crosslinking agent to be crosslinked. As a result, the specific resin being a reaction product of the base resin and the carbodiimide crosslinking agent is generated. In the present process, addition of the carbodiimide crosslinking agent is preferably followed by heating and stirring of the pigment particle dispersion. The heating temperature is at least 70° C. and no greater than 95° C., for example. The heating time is 30 minutes or longer and 2 hours or shorter, for example.

(Addition Process)

In the present process, the aqueous medium is added to the pigment particle dispersion after the crosslinking process. As a result, the ink can be obtained. Note that in the present process, any other component (specifically, at least one of a surfactant, a solution stabilizer, a moisturizing agent, a penetrating agent, and a viscosity modifier) may be additionally added according to necessity. In the present process, the resultant mixed liquid after addition of the aqueous medium is preferably stirred using a stirrer. Foreign matter and coarse particles contained in the resultant ink may be removed using a filter (e.g., a filter with a pore diameter of no greater than 5 μm).

### EXAMPLES

The following describes examples of the present disclosure. However, the present disclosure is not limited to the following examples.

### [Preparation of Resin (A)]

A four-necked flask equipped with a stirrer, a nitrogen inlet tube, a condenser, and a dripping funnel was charged with 100.0 parts by mass of isopropyl alcohol and 250.0 parts by mass of methyl ethyl ketone. Separately, a monomer solution was prepared by mixing 30.0 parts by mass of benzyl methacrylate, 10.0 parts by mass of n-butyl acrylate, parts by mass of methacrylic acid, 5.0 parts by mass of 4-aclyloyl morpholine, 24.3 parts by mass of methoxy-polyethylene glycol acrylate (“LIGHT ACRYLATE (registered Japanese trademark) 130A”, product of Kyoeisha Chemical Co., Ltd.), and 0.3 parts by mass of azobisisobutyronitrile (AIBN, polymerization initiator). Furthermore, 150.0 parts by mass of methyl ethyl ketone and 0.1 parts by mass of AIBN were mixed to prepare a methyl ethyl ketone solution.

Next, a nitrogen atmosphere was created inside the four-necked flask by introducing a nitrogen gas into the four-necked flask. Next, the full amount of the aforementioned monomer solution was fed into the four-necked flask over 2 hours using the dripping funnel while heating reflux at 70° C. was performed on the contents of the four-necked flask. After the monomer solution was fed, heating reflux at 70° C. was further performed on the contents of the four-necked flask over 6 hours. Next, the full amount of the aforementioned methyl ethyl ketone solution was fed into the four-necked flask over 15 minutes using the dripping funnel while heating reflux at 70° C. was performed on the contents of the four-necked flask. After the methyl ethyl ketone solution was fed, heating reflux at 70° C. was further performed on the contents of the four-necked flask over 5 hours. Through the above, a resin solution containing a resin (A) being a styrene-(meth)acrylic resin was obtained. The resin (A) was isolated by distilling methyl ethyl ketone and isopropyl alcohol from the resin solution.

### [Preparation of Resins (B) to (M)]

Resins (B) to (M) were prepared according to the same method as that for preparing the resin (A) in all aspects other than the types and amounts of the monomers used were changed to those shown below in Table 1 in monomer solution preparation.

Abbreviations used below in Table 1 are explained.

130A: methoxy polyethylene glycol acrylate (“LIGHT ACRYLATE (registered Japanese trademark) 130A”, product of Kyoeisha Chemical Co., Ltd.), number of repeats of —CH₂—CH₂—O—: approximately 9

AM90G: methoxy polyethylene glycol acrylate (“NK ESTER AM-90G”, product of SHIN-NAKAMURA CHEMICAL Co., Ltd.), number of repeats of —CH₂—CH₂—O—: approximately 9

TABLE 1

| | A | B | C | D | E | F | G |
|---|---|---|---|---|---|---|---|
| Benzyl methacrylate | 30.0 | 30.0 | 30.0 | 30.0 | 30.0 | 30.0 | 30.0 |
| Styrene | — | — | — | — | — | — | — |
| α-Methylstyrene | — | — | — | — | — | — | — |
| Ethyl methacrylate | — | — | — | — | — | — | — |
| N-butyl acrylate | 10.0 | 10.0 | 10.0 | 10.0 | 10.0 | 10.0 | 10.0 |
| Methacrylic acid | 30.7 | 30.7 | 30.7 | 30.7 | 30.7 | 30.7 | 30.7 |
| 130A | 24.3 | 24.3 | 28.3 | 28.3 | 11.3 | 11.3 | 28.8 |
| AM90G | — | — | — | — | — | — | — |
| 2-Acryloyl morpholine | 5.0 | — | 1.0 | — | 18.0 | — | 0.5 |
| Vinyl pyrrolidone | — | 5.0 | — | 1.0 | — | 18.0 | — |

| | H | I | J | K | L | M |
|---|---|---|---|---|---|---|
| Benzyl methacrylate | 30.0 | 30.0 | 30.0 | — | — | — |
| Styrene | — | — | — | 30.0 | 14.0 | 30.0 |
| α-Methylstyrene | — | — | — | — | 16.0 | — |
| Ethyl methacrylate | — | — | — | 10.0 | — | — |
| N-butyl acrylate | 10.0 | 10.0 | 10.0 | — | 10.0 | 10.0 |
| Methacrylic acid | 30.7 | 30.7 | 30.7 | 30.7 | 30.7 | 30.7 |
| 130A | 28.8 | 8.3 | 8.3 | 24.3 | 24.3 | — |
| AM90G | — | — | — | — | — | 24.3 |
| 2-Acryloyl morpholine | — | 21.0 | — | 5.0 | 5.0 | 5.0 |
| Vinyl pyrrolidone | 0.5 | — | 21.0 | 1 | — | — |

<Ink Preparation>

Inks of Examples 1 to 18 and Comparative Examples 1 to 9 shown below in Table 2 were prepared according to the following methods. First, crosslinking agents and surfactants used in Examples are indicated below.

Crosslinking agent (SV): carbodiimide crosslinking agent-containing aqueous solution (“CARBODILITE (registered Japanese trademark) SV-02”, product of Nisshinbo Chemical Inc.), effective component concentration 40% by mass

Crosslinking agent (L2): carbodiimide crosslinking agent-containing aqueous solution (“CARBODILITE (registered Japanese trademark) V-02-L2), effective component concentration 40% by mass

Crosslinking agent (V02): carbodiimide crosslinking agent-containing aqueous solution (“CARBODILITE (registered Japanese trademark) V-2), effective component concentration 40% by mass

Crosslinking agent (EX): epoxy crosslinking agent (“DENACOL (registered Japanese trademark) EX-810”, product of Nagase ChemteX Corporation), ethylene glycol diglycidyl ether

Surfactant A: ethylene oxide adduct of acetylene glycol (“SURFYNOL (registered Japanese trademark) 420”, product of Nissin Chemical Industry Co., Ltd.)

Surfactant B: amphiphilic polymer (“POLYFLOR (registered Japanese trademark) KL-850”, product of Kyoeisha Chemical Co., Ltd.)

### Example 1

(Neutralization Treatment)

An aqueous resin solution with a resin concentration of 20% by mass was prepared by mixing 20.0 parts by mass of the resin (A), potassium hydroxide, and water using a disperser (“ROCKING SHAKER”, product of Seiwa Giken Co., Ltd.). The amount of the potassium hydroxide added was an amount (1.6 parts by mass in Example 1) corresponding to 40% by mass of a neutralization equivalent of the resin (A). Through the above, the neutralization rate of the resin (A) was adjusted to 40%. The amount of the water added was an amount (78.4 parts by mass in Example 1) that made 100 parts by mass of the aqueous resin solution. Note that the neutralization equivalent of the resin (A) was calculated based on the amount of the methacrylic acid used for synthesis of the resin (A).

(Dispersion Treatment)

A mixture was obtained by mixing 15.0 parts by mass of a pigment (BK) (“PRINTEX (registered Japanese trademark) 85”, product of Orion Engineered Carbons KK, carbon black), 22.5 parts by mass of the aforementioned aqueous resin solution (containing 4.5 parts by mass of the resin (A)), 0.1 parts by mass of a defoaming agent (“SN DEFOAMER 1340”, product of SAN NOPCO LIMITED, amide wax surfactant), and ion exchange water. The amount of the ion exchange water added was an amount (62.4 parts by mass in Example 1) that made 100 parts by mass of the mixture.

The resultant mixture was dispersed for 4 hours using a media type disperser (“DYNO-MILL”, product of Willy A. Bachofen AG (WAB)). In the dispersion, zirconia beads with a diameter of 0.5 mm were used as a medium. The filling rate of the medium was 60% by volume to the capacity of a vessel of the disperser. The treatment temperature (chiller temperature) in the dispersion treatment was set to 10° C. After the dispersion treatment, the medium was removed from the contents of the media type disperser, thereby obtaining a pigment particle dispersion. Next, the pigment particle dispersion was filtered using a filter with a pore diameter of 5 μm to remove foreign matter and coarse particles.

(Crosslinking Treatment)

A three-necked flask equipped with a thermometer and a stirring impeller was used as a reaction vessel. The filtered pigment particle dispersion in an amount of 100.0 parts by mass was added into the reaction vessel. The temperature of the contents of the reaction vessel was kept at 30° C. using a water bath. Next, the reaction vessel was charged with 0.92 parts by mass (effective component 0.37 parts by mass) of a crosslinking agent (SV) being an aqueous solution of a carbodiimide crosslinking agent. Next, the temperature of the contents of the reaction vessel was increased to 80° C. at a heating rate of 0.5° C./min. while the contents of the reaction vessel were stirred at 250 rpm. Next, the contents of the reaction vessel were stirred at 250 rpm for 1 hours while the temperature of the contents of the reaction vessel was kept at 80° C. This caused a reaction of the contents of the reaction vessel. Through the reaction, the resin (A) was crosslinked by the crosslinking agent (SV) to form a specific resin. Next, the contents of the reaction vessel were left to stand for cooling until the temperature thereof became room temperature. Through the above, a crosslinked pigment particle dispersion was obtained.

(Addition Treatment)

A container was charged with 50.0 parts by mass of the crosslinked pigment particle dispersion (approximately 7.5 parts by mass of the pigment, approximately 2.25 parts by mass of the resin (A)), 0.5 parts by mass of a nonionic surfactant A (“SURFYNOL (registered Japanese trademark) 420”, product of Nissin Chemical Industry Co., Ltd.), 2.0 parts by mass of glycerin, 6.0 parts by mass of 3-methyl-1,5-pentanediol, 3.0 parts by mass of triethylene glycol monobutyl ether, and ion exchange water to obtain a mixed liquid. The amount (38.5 parts by mass in Example 1) of the ion exchange water charged was an amount that made 00.0 parts by mass of the total amount of the mixed liquid. The resultant mixed liquid was stirred at a rotational speed of 400 rpm using a stirrer (“THREE-ONE MOTOR BL-600”, product of Shinto Scientific Co., Ltd.). The mixed liquid after the stirring was filtered using a filter (pore size: 5 μm). Through the above, the ink of Example 1 was obtained.

### Examples 2 to 18 and Comparative Examples 1 to 9

The inks of Examples 2 to 18 and Comparative Examples 1 to 9 were prepared according to the same method as that for preparing the ink of Example 1 in all aspects other than that the types and amounts of components used in each treatment were changed to those shown below in Tables 2 to 4.

Abbreviations used below in Tables 2 to 4 are explained below.

Part: part by mass

Dispersion: crosslinked pigment particle dispersion

TGMBE: triethylene glycol monobutyl ether

MPD: 3-methyl-1,5-pentanediol

MBD: 3-methyl-1,3-butanediol

1,2-PD: 1,2-pentanediol

TABLE 2

| | | | Example | | | | | | | | |
|---|---|---|---|---|---|---|---|---|---|---|---|
| | | | 1 | 2 | 3 | 4 | 5 | 6 | 7 | 8 | 9 |
| Neutralization | Resin | Type | A | B | C | D | E | F | A | B | A |
| treatment | | Part | 20.0 | 20.0 | 20.0 | 20.0 | 20.0 | 20.0 | 20.0 | 20.0 | 20.0 |
| | Ion exchange water | Part | 78.4 | 78.4 | 78.4 | 78.4 | 78.4 | 78.4 | 79.1 | 79.1 | 78.1 |
| | KOH | Part | 1.60 | 1.60 | 1.60 | 1.60 | 1.60 | 1.60 | 0.88 | 0.88 | 1.92 |
| | Neutralization rate | % | 40 | 40 | 40 | 40 | 40 | 40 | 22 | 22 | 48 |
| Crosslinking | Crosslinking agent | Type | SV | SV | SV | SV | SV | SV | SV | SV | SV |
| treatment | | Part | 0.92 | 0.92 | 0.92 | 0.92 | 0.92 | 0.92 | 1.20 | 1.20 | 0.80 |
| Addition | Dispersion | Part | 50.0 | 50.0 | 50.0 | 50.0 | 50.0 | 50.0 | 50.0 | 50.0 | 50.0 |
| treatment | Surfactant A | Part | 0.5 | 0.5 | 0.5 | 0.5 | 0.5 | 0.5 | 0.5 | 0.5 | 0.5 |
| | Surfactant B | Part | — | — | — | — | — | — | — | — | — |
| | Glycerin | Part | 2.0 | 2.0 | 2.0 | 2.0 | 2.0 | 2.0 | 2.0 | 2.0 | 2.0 |
| | MPD | Part | 6.0 | 6.0 | 6.0 | 6.0 | 6.0 | 6.0 | 6.0 | 6.0 | 6.0 |
| | MBD | Part | — | — | — | — | — | — | — | — | — |
| | TGMBE | Part | 3.0 | 3.0 | 3.0 | 3.0 | 3.0 | 3.0 | 3.0 | 3.0 | 3.0 |
| | 1,2-PD | Part | — | — | — | — | — | — | — | — | — |
| | Ion exchange water | Part | Rest | | | | | | | | |
| | Total | Part | 100 | 100 | 100 | 100 | 100 | 100 | 100 | 100 | 100 |

TABLE 3

| | | | Example | | | | | | | | |
|---|---|---|---|---|---|---|---|---|---|---|---|
| | | | 10 | 11 | 12 | 13 | 14 | 15 | 16 | 17 | 18 |
| Neutralization | Resin | Type | B | A | A | A | A | A | K | L | M |
| treatment | | Part | 20.0 | 20.0 | 20.0 | 15.0 | 25.0 | 20.0 | 20.0 | 20.0 | 20.0 |
| | Ion exchange water | Part | 78.1 | 78.4 | 78.4 | 83.8 | 73.0 | 78.4 | 78.4 | 78.4 | 78.4 |
| | KOH | Part | 1.92 | 1.60 | 1.60 | 1.20 | 2.00 | 1.60 | 1.60 | 1.60 | 1.60 |
| | Neutralization rate | % | 48 | 40 | 40 | 40 | 40 | 40 | 40 | 40 | 40 |
| Crosslinking | Crosslinking agent | Type | SV | L2 | SV | SV | SV | V02 | SV | SV | SV |
| treatment | | Part | 0.80 | 0.83 | 0.92 | 0.92 | 0.92 | 1.26 | 0.92 | 0.92 | 0.92 |
| Addition | Dispersion | Part | 50.0 | 50.0 | 50.0 | 50.0 | 50.0 | 50.0 | 50.0 | 50.0 | 50.0 |
| treatment | Surfactant A | Part | 0.5 | 0.5 | — | 0.5 | 0.5 | 0.5 | 0.5 | 0.5 | 0.5 |
| | Surfactant B | Part | — | — | 0.5 | — | — | — | — | — | — |
| | Glycerin | Part | 2.0 | 2.0 | 5.0 | 2.0 | 2.0 | 2.0 | 2.0 | 2.0 | 2.0 |
| | MPD | Part | 6.0 | 6.0 | — | 6.0 | 6.0 | 6.0 | 6.0 | 6.0 | 6.0 |
| | MBD | Part | — | — | 20.0 | — | — | — | — | — | — |
| | TGMBE | Part | 3.0 | 3.0 | — | 3.0 | 3.0 | 3.0 | 3.0 | 3.0 | 3.0 |
| | 1,2-PD | Part | — | — | 10.0 | — | — | — | — | — | — |
| | Ion exchange water | Part | Rest | | | | | | | | |
| | Total | Part | 100 | 100 | 100 | 100 | 100 | 100 | 100 | 100 | 100 |

TABLE 4

| | | | Comparative Example | | | | | | | | |
|---|---|---|---|---|---|---|---|---|---|---|---|
| | | | 1 | 2 | 3 | 4 | 5 | 6 | 7 | 8 | 9 |
| Neutralization | Resin | Type | G | H | I | J | A | B | A | B | A |
| treatment | | Part | 20.0 | 20.0 | 20.0 | 20.0 | 20.0 | 20.0 | 20.0 | 20.0 | 20.0 |
| | Ion exchange water | Part | 78.4 | 78.4 | 78.4 | 78.4 | 79.28 | 79.28 | 77.9 | 77.9 | 78.4 |
| | KOH | Part | 1.60 | 1.60 | 1.60 | 1.60 | 0.72 | 0.72 | 2.10 | 2.10 | 1.60 |
| | Neutralization rate | % | 40 | 40 | 40 | 40 | 18 | 18 | 52 | 52 | 40 |
| Crosslinking | Crosslinking agent | Type | SV | SV | SV | SV | SV | SV | SV | SV | EX |
| treatment | | Part | 0.92 | 0.92 | 0.92 | 0.92 | 1.3 | 1.3 | 0.74 | 0.74 | 0.24 |
| Addition | Dispersion | Part | 50.0 | 50.0 | 50.0 | 50.0 | 50.0 | 50.0 | 50.0 | 50.0 | 50.0 |
| treatment | Surfactant A | Part | 0.5 | 0.5 | 0.5 | 0.5 | 0.5 | 0.5 | 0.5 | 0.5 | 0.5 |
| | Surfactant B | Part | — | — | — | — | — | — | — | — | — |
| | Glycerin | Part | 2.0 | 2.0 | 2.0 | 2.0 | 2.0 | 2.0 | 2.0 | 2.0 | 2.0 |
| | MPD | Part | 6.0 | 6.0 | 6.0 | 6.0 | 6.0 | 6.0 | 6.0 | 6.0 | 6.0 |
| | MBD | Part | — | — | — | — | — | — | — | — | — |
| | TGMBE | Part | 3.0 | 3.0 | 3.0 | 3.0 | 3.0 | 3.0 | 3.0 | 3.0 | 3.0 |
| | 1,2-PD | Part | — | — | — | — | — | — | — | — | — |
| | Ion exchange water | Part | Rest | | | | | | | | |
| | Total | Part | 100 | 100 | 100 | 100 | 100 | 100 | 100 | 100 | 100 |

<Evaluation>

With respect to each of the inks of Examples 1 to 18 and Comparative Examples 1 to 9, nozzle clogging and preservation stability were evaluated by the following methods. Note that the evaluations were carried out at a temperature of 25° C. and a relative humidity of 60%, unless otherwise specifically noted. Evaluation results are shown below in Tables 5 and 6.

### [Nozzle Clogging]

In evaluation of nozzle clogging, an inkjet recording apparatus (test apparatus produced by KYOCERA Document Solutions Japan Inc.) with a line type recording head was used as an evaluation apparatus. With respect to each of the inks of Examples 1 to 18 and Comparative Examples 1 to 9 being evaluation targets, the ink was loaded into an ink tank for black ink of the evaluation apparatus.

A solid image (150 mm×200 mm) was formed on 100 sheets of matt paper (“SUPER FINE PAPER”, product of Seiko Epson Corporation) in succession using the evaluation apparatus. Next, purging was performed for ink pursing from the recording head of the evaluation apparatus. Next, wiping was performed in a manner to wipe the ink ejection surface of the recording head of the evaluation apparatus using a cleaning wiper. Next, a nozzle check pattern was formed on a sheet of the matt paper using the evaluation apparatus. As a result, it was confirmed that with respect to each of the evaluation targets, the ink has been ejected from all the nozzles (7968 nozzles) of the recording head. That is, the number of nozzles with nozzle clogging was 0. Next, purging and wiping were performed on the recording head of the evaluation apparatus. Next, the evaluation apparatus was left to stand for 7 days with the recording head uncapped. Next, the same purging and wiping as above were performed on the recording head of the evaluation apparatus. Next, a nozzle check pattern was formed on a sheet of the matt paper using the evaluation apparatus. Thereafter, the formed nozzle check pattern was observed to count the number of nozzles with nozzle clogging. The ratio of the number of nozzles with nozzle clogging to the number of all the nozzles of the recording head of the evaluation apparatus was taken to be an evaluation value for nozzle clogging. Nozzle clogging was evaluated according to the following criteria.

(Criteria of Nozzle Clogging)

A (good): evaluation value of less than 10%

B (poor): evaluation value of 10% or more

### [Preservation Stability]

With respect to each of the inks of Examples 1 to 18 and Comparative Examples 1 to 9 being evaluation targets, the ink was loaded into a measurement cell (optical path length: 1 mm). The measurement cell was set in a spectrophotometer (“U-3000”, product of Hitachi High-Tech Science Corporation), and the transmission spectrum of the measurement target was measured. The measurement wavelength was set to 610 nm. The obtained measurement value was taken to be an initial transmittance.

Next, a polyethylene vessel was filled with the measurement target, and sealed. The polyethylene vessel was left to stand in a constant temperature bath (set temperature: for 1 week (heating treatment). With respect to each measurement target after the heating treatment, the transmittance was measured according to the same method as that for measuring the initial transmittance. The obtained measurement value was taken to be a post-treatment transmittance. A change rate of the transmittance was calculated using an equation “change rate of transmittance=100×(absolute value of difference between initial transmittance and post-treatment transmittance)/(initial transmittance)”. Preservation stability was evaluated according to the following criteria.

(Criteria of Preservation Stability)
A (good): change rate of transmittance of less than 5%
B (poor): change rate of transmittance of 5% or more

TABLE 5

| | | Example | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Nozzle | Evaluation | 5 | 5 | 8 | 9 | 2 | 1 | 7 | 6 | 4 | 4 | 3 | 6 | 3 | 8 |
| clogging | value [%] | | | | | | | | | | | | | | |
| | Rating | A | A | A | A | A | A | A | A | A | A | A | A | A | A |
| Preservation | Evaluation | 2 | 2 | 3 | 4 | 4 | 4 | 1 | 1 | 4 | 4 | 4 | 3 | 4 | 1 |
| stability | value [%] | | | | | | | | | | | | | | |
| | Rating | A | A | A | A | A | A | A | A | A | A | A | A | A | A |

TABLE 6

| | | Example | | | | Comparative Example | | | | | | | | |
|---|---|---|---|---|---|---|---|---|---|---|---|---|---|---|
| | | 15 | 16 | 17 | 18 | 1 | 2 | 3 | 4 | 5 | 6 | 7 | 8 | 9 |
| Nozzle | Evaluation | 1 | 6 | 8 | 5 | 10 | 11 | 10 | 0 | 10 | 10 | 2 | 1 | 0 |
| clogging | value [%] | | | | | | | | | | | | | |
| | Rating | A | A | A | A | B | B | A | A | B | B | A | A | A |
| Preservation | Evaluation | 4 | 3 | 4 | 3 | 7 | 7 | 6 | 5 | 0 | 0 | 6 | 7 | 5 |
| stability | value [%] | | | | | | | | | | | | | |
| | Rating | A | A | A | A | B | B | B | B | A | A | B | B | B |

As shown in Tables 1 to 6, the inks of Examples 1 to 18 contained an aqueous medium and pigment particles dispersed in the aqueous medium. The pigment particles contained a pigment and a specific resin. The specific resin included an acid group and a first repeating unit derived from a specific monomer, and had a crosslinking structure derived from a carbodiimide crosslinking agent. The specific resin had a neutralization rate of at least 20% and no greater than 50%. The first repeating unit had a percentage content in the specific resin of at least 1.0% by mass and no greater than 20.0% by mass. The specific monomer had a morpholine structure or a pyrrolidone structure. The inks of Examples 1 to 18 inhibited occurrence of nozzle clogging. Furthermore, the inks of Examples 1 to 18 had excellent preservation stability.

By contrast, the first repeating unit had a percentage content in the specific resin of less than 1.0% by mass in each of the inks of Comparative Examples 1 and 2. The specific resins used in the inks of Comparative Examples 1 and 2 were insufficiently hydrophilic due to the presence of the morpholine or pyrrolidone structure to an insufficient extent. As a result, the inks of Comparative Examples 1 and 2 did not inhibit nozzle clogging and had poor preservation stability.

In each of the inks of Comparative Examples 3 and 4, the first repeating unit had a percentage content in the specific resin of greater than 20.0% by mass. The specific resins in the inks of Comparative Examples 3 and 4 were excessively hydrophilic due to the excessive amount of the morpholine or pyrrolidone structure. Accordingly, the specific resins in the inks of Comparative Examples 3 and 4 were thought to be readily desorbed from the pigment particles. As a result, the inks of Comparative Examples 3 and 4 had poor preservation stability.

The specific resins in the inks of Comparative Examples 5 and 6 each had a neutralization rate of less than 20%. The specific resins used in the inks of Comparative Examples 5 and 6 were insufficiently hydrophilic due to their excessively low neutralization rate. It is therefore thought that once the pigment particles of either ink of Comparative Examples 5 or 6 agglomerated around the nozzles, the resultant agglomeration was difficult to wash out. As a result, the inks of Comparative Examples and 6 did not inhibit nozzle clogging.

The specific resins of the inks of Comparative Examples 7 and 8 each had a neutralization rate of greater than 50%. In order to form a crosslinking structure in a specific resin, a sufficient amount of an unneutralized acid group is needed to be present in the specific resin. However, the specific resins used in the inks of Comparative Examples 7 and 8 did not form sufficient crosslinking structure due to their excessively high neutralization rates. Therefore, it is thought that the specific resins of the inks of Comparative Examples 7 and 8 readily agglomerated due to their low resistance to the organic solvent. As a result, the inks of Comparative Examples 7 and 8 had poor preservation stability.

The ink of Comparative Example 9 used an epoxy crosslinking agent for crosslinking the specific resin. The specific resin used in the ink of Comparative Example 9 was excessively hydrophilic due to having a highly hydrophilic crosslinking structure formed by the epoxy crosslinking agent. Therefore, the specific resin in the ink of Comparative Example 9 was thought to be readily desorbed from the pigment particles. As a result, the ink of Comparative Example 9 was poor in preservation stability.

What is claimed is:

1. An inkjet ink comprising:
an aqueous medium; and pigment particles dispersed in the aqueous medium, wherein
the pigment particles contain a pigment and a specific resin,
the specific resin includes an acid group and a first repeating unit derived from a specific monomer, and has a crosslinking structure derived from a carbodiimide crosslinking agent,
the specific resin has a neutralization rate of at least 20% and no greater than 50%,
the first repeating unit has a percentage content in the specific resin of at least 1.0% by mass and no greater than 20.0% by mass, and
the specific monomer has a morpholine structure or a pyrrolidone structure.

2. The inkjet ink according to claim 1, wherein
the specific monomer includes vinyl pyrrolidone or 2-acryloyl morpholine.

3. The inkjet ink according to claim 1, wherein
the pigment particles have a volume median diameter of at least 80 nm and no greater than 130 nm.

4. The inkjet ink according to claim 1, wherein
the specific resin further includes a second repeating unit derived from a monomer with a polyethylene glycol structure, and
the second repeating unit has a percentage content in the specific resin of at least 10.0% by mass and no greater than 30.0% by mass.
